(19) United States
(12) Patent Application Publication
(10) Pub. No.: US 2019/0105623 A1
(43) Pub. Date: Apr. 11, 2019

(54) FEED ADDITIVE DELIVERY DEVICE, SYSTEM COMPRISING THE DEVICE, AND METHOD FOR USE

(71) Applicant: MWI Veterinary Supply Co., Boise, ID (US)

(72) Inventors: Robert A. Harrington, Amarillo, TX (US); Larry D. Elgin, Amarillo, TX (US)

(73) Assignee: MWI Veterinary Supply Co., Boise, ID (US)

(21) Appl. No.: 16/212,404

(22) Filed: Dec. 6, 2018

Related U.S. Application Data
(63) Continuation of application No. PCT/US2017/036805, filed on Jun. 9, 2017.
(60) Provisional application No. 62/349,312, filed on Jun. 13, 2016.

(51) Int. Cl. B01F 15/02; B01F 7/00; B01F 15/00; A23N 17/00; A23K 20/142

(52) U.S. Cl. CPC B01F 15/0217; B01F 15/0235; B01F 15/0261; B01F 15/0238; B01F 2215/0008; B01F 15/00194; A23N 17/007; A23K 20/142; B01F 7/0025

(57) ABSTRACT

Embodiments of a feed additive delivery device, a system comprising a micro weigh machine and the feed additive delivery device, and a method for using the device and system are disclosed. A particular exemplary feed additive delivery device comprised a feed additive hopper for suppling feed additive to a rotary valve that meters feed additive from the hopper to a blow through assembly having an assembly inlet that receives feed additive from the rotary valve, an assembly outlet through which feed additive is dispensed, and an air port for drawing air into the assembly to facilitate feed additive dispensation through the assembly outlet. The system is useful for batching a composition comprising an animal feed and at least one coated animal feed additive, a delicate animal feed additive, or combinations thereof. For certain embodiments the animals are ruminants and the coated feed additive is a coated methionine product.

### CROSS REFERENCE TO RELATED APPLICATIONS

This is a continuation application of International Application No. PCT/US2017/036805, filed on Jun. 9, 2017, which claims the benefit of U.S. Provisional Application No. 62/349,312, which was filed on Jun. 13, 2016. These prior applications are incorporated herein by reference in their entirety.

### FIELD

The present disclosure concerns a device for dispensing feed additives, particularly delicate and/or coated feed additives, to form animal feed compositions, a system comprising a micro weigh machine and the feed additive delivery device, and a method for using the device and system.

### BACKGROUND

Feed additive supplements are commonly administered to cattle and poultry. Such supplements include vitamins, minerals, proteins, enzymes, amino acids, therapeutics, and nutritional supplements that provide a balanced diet and protect the livestock from disease. Commercially prepared dry additives premixed with some dry diluting filler material have been fed to livestock. The premix was either mixed with the feed ration before delivery to the animals or spread on the feed at the feed trough. Premixes were difficult to mix evenly with the feed, and additives of different densities tended to segregate in stored premixes, increasing the likelihood that animals received too much or too little of a given additive. Premixes also limited the choices of additive combinations that livestock feeders could feed their animals to those combinations available commercially, and precluded feeding different animal groups different combinations and dosages of additives to meet their differing needs.

Apparatuses were then developed for dispensing livestock feed additives for mixing with livestock feed rations that metered the desired amount of each feed additive on a volumetric basis. Volumetric metering also had substantial drawbacks. For example, volumetric metering often dispensed feed additive amounts too inaccurately as a result of changes in product densities, humidity effects on additives, particle size, particle shape, etc. Embodiments of apparatuses for dispensing feed additives primarily on a weight basis, referred to herein as micro weigh machines, also are known. Exemplary embodiments of micro weigh machines are disclosed by U.S. Pat. Nos. 3,806,001 and 4,815,042, which are incorporated herein by reference. These weigh machine embodiments dispense multiple dry and liquid additives from separate storage containers into a weigh hopper, and load cells determine the weights of the different additives dispensed.

Certain additives have proved difficult to dispense using known micro weigh machines without deleteriously impacting the product dispensed. A number of factors contribute to these difficulties, including product formulation, particle size and particle shape. Commercially available methionine products provide one example of a feed additive formulation that has proved difficult to dispense using micro weigh machines. Methionine is a limiting amino acid in ruminants that is essential for milk production and milk protein synthesis. Methionine breaks down in the rumen of ruminants, and commercial products therefore comprise methionine coated with a pH-sensitive polymer to preclude methionine degradation in the rumen, while allowing appropriate adsorption levels in the digestive tract. Coated methionine products are administered to lactating cattle in the feed ration to satisfy nutritional requirements, optimize feed cost, help reduce nitrogen excretion, and help improve milk production performance prior feed additive dispensing devices break or otherwise disrupt the outer polymer coating of methionine feed additives so substantially as to render the feed additive unsuitable for subsequent use.

### SUMMARY

The present disclosure concerns a feed additive delivery device, a system comprising a micro weigh machine and the feed additive delivery device, and a method for using the device and system to dispense delicate feed additives to form animal feed formulations that address problems associated with known methods and devices. One disclosed embodiment of a feed additive delivery device comprises a feed additive source, such as a hopper having a first wall portion and a second wall portion angled relative to the first wall portion to facilitate feed additive flow from the device; an assembly having an assembly inlet that receives feed additive from the source and an assembly outlet through which feed additive is dispensed; at least one feed additive delivery line coupled to the assembly outlet; and a pressurized fluid source for delivering pressurized fluid to the device to dispense feed additive from the assembly through the feed additive delivery line. For certain embodiments the assembly is a blow through assembly, and feed additive may be drawn from and/or blown through the assembly. The pressurized fluid source may deliver pressurized air to the at least one feed additive delivery line downstream of the blow through delivery assembly to create a region of lower pressure to draw product from the assembly.

Certain disclosed embodiments further comprise a metering device positioned between the source and the blow through assembly for metering feed additive to the assembly. For example, the metering device may comprise a rotary valve having plural vanes, such as 8 to 64 vanes, with certain working embodiments having 8 or 16 vanes, that define feed additive receiving regions therebetween to receive a known volume of feed additive. The rotary valve is coupled to a motor and gear box, and the motor may further comprise a frequency converter coupled to the motor, for rotating the valve at a desired rate to meter feed additive to a feed additive receiving chamber of the blow through assembly. One exemplary working embodiment comprised a 6 inch rotary valve having 8 or 16 vanes, the rotary valve being coupled to (a) a motor having a frequency converter, and (b) to an 18:1 gear box for rotating the valve at a desired rotation rate.

Particular disclosed embodiments of the feed additive delivery device include a blow through assembly that comprises an air port for drawing air into the assembly. The air port facilitates feed additive dispensation through at least one assembly outlet port. Such embodiments typically include first and second feed additive delivery lines, and a compressor for delivering air to the feed additive delivery lines. The feed additive delivery lines typically include independently controllable solenoid valves for regulating air flow thereto. A control computer, such as a control computer of a micro weigh machine, controls valve actuation. Actuation of the solenoid valves produces air flow in a first feed additive delivery line in a feed additive delivery direction and produces air flow through the second feed additive delivery line in an opposite direction back to the assembly.

A particular disclosed embodiment of a feed additive delivery device comprised a feed additive hopper for suppling feed additive to a rotary valve. The rotary valve is driven by a motor at selectable rotation rates and comprises plural vanes that define feed additive receiving regions therebetween to receive a known volume of feed additive. The rotary valve meters feed additive from the hopper to a blow through assembly having an assembly inlet that receives feed additive from the rotary valve, an assembly outlet through which feed additive is dispensed, and an air port for drawing air into the assembly to facilitate feed additive dispensation through the assembly outlet port. A pressurized air source delivers pressurized air to first and second feed additive delivery lines coupled to the assembly outlet, the first and second feed additive delivery lines comprising independently controllable solenoid valves coupled to a control computer of a micro weigh machine. Actuation of the solenoid valves draws feed additive from the blow through assembly and through a feed additive delivery line. The hopper, rotary valve and blow through assembly are operably associated with a scale or load cell to determine the weight of feed additive dispensed thereby.

A system comprising a micro weigh machine and the feed additive delivery device also is disclosed. The feed additive delivery device may deliver feed additive directly onto feed, such as into a vehicle housing feed for transportation to feed animals for administration, into a mixer hopper of the micro weigh machine, into an aqueous feed additive slurry stream provided by the micro weigh machine, etc., and any combination thereof. The micro weigh machine includes a control computer operatively coupled to the feed additive delivery device for controlling dispensation of feed additive thereby. The micro weigh machine includes plural feed additive storage containers for separately storing feed additives selected from, for example, antibiotics, amino acids, therapeutics, proteins, enzymes, vitamins, other nutritional supplements, etc. The micro weigh machine can determine weights dispensed by associating a scale or load cell with each of the plural storage containers, taking a first weight measurement before feed additive dispensation and a second weight after feed additive dispensation. Alternatively, the micro weigh machine can include a weigh hopper associated with a scale or load cell, and the weight of each feed additive dispensed into the weigh hopper can be determined after each addition to the weigh hopper. For particular embodiments the delivery device dispenses coated methionine, and the micro weigh machine dispenses multiple different additives other than coated methionine, to form a feed and feed additive composition for administration to animals.

A method for using the device and system also is disclosed. The method is useful for batching a composition comprising an animal feed and at least one coated animal feed additive, a delicate animal feed additive, or combinations thereof. For certain disclosed embodiments of the method, the animal is a ruminant, and the coated feed additive is a coated methionine product. The feed additive device delivers intact, coated methionine feed additive to form a feed composition comprising from about 7 grams/head to about 20 grams/head coated methionine.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates an embodiment of a feed additive delivery device according to the present disclosure.

FIG. 2 illustrates an embodiment of a rotary valve assembly comprising a rotary valve (enlarged, separated view) for a feed additive delivery device according to the present disclosure.

FIG. 3 is a perspective view of one embodiment of a blow through plate assembly.

FIG. 4 is a plan view of the blow through plate assembly illustrated in FIG. 3.

FIG. 5 is a schematic view of electrical relays and circuits for an embodiment of a feed additive delivery device according to the present disclosure.

FIG. 6 illustrates certain method steps used to dispense a feed additive using disclosed embodiments of the delivery device.

FIG. 7 is a perspective view showing certain components of an exemplary prior art micro weigh machine.

FIG. 8 is a perspective view illustrating certain internal components of the micro weigh machine of FIG. 7.

FIG. 9 is an enlarged, front elevational view of the main cabinet of FIG. 7 with the cabinet panels removed to show internal components.

### DETAILED DESCRIPTION

### I. Definitions

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood by a person of ordinary skill in the art to which this disclosure pertains. Although methods and materials similar or equivalent to those described herein can be used to practice or test the subject matter of the present disclosure, suitable methods and materials are described below. The materials, methods, and examples are illustrative only and are not intended to be limiting. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

Feed Animal: Includes animal species raised for human consumption, particularly ruminants, swine and poultry.

Feed: Anything that may be consumed by an animal, including both solids and liquids (e.g., a feed ration).

Feed Additive: Anything that is added to animal feed including, without limitation, nutritional supplements, antibiotics, therapeutics, proteins, enzymes, vitamins, amino acids, and combinations thereof.

Ruminant: Includes bovine, sheep, goat, deer, bison, buffalo, elk, llama, alpaca, and antelope.

### II. Feed Additive Delivery Device

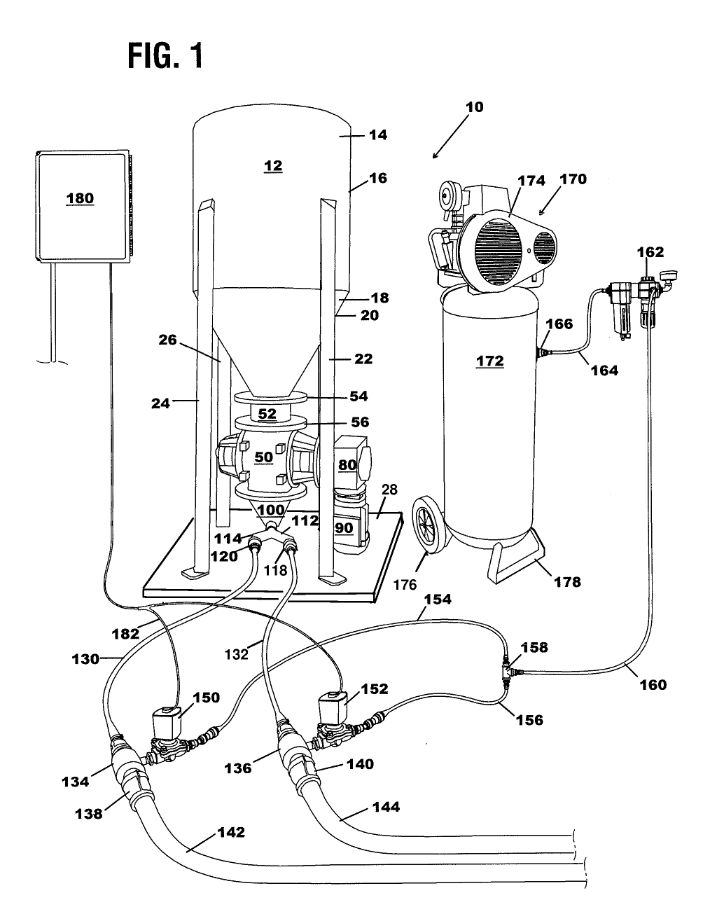

FIG. 1 illustrates an embodiment of a feed additive dispensing device 10 according to the present disclosure. Device 10 includes a storage hopper 12 for receiving and storing a feed additive. In an exemplary working embodiment, the hopper 12 had sufficient volume to hold 300 pounds of a product having a density of about 40 pounds/ft³. In the illustrated embodiment, hopper 12 comprises a first portion 14 sized and dimensioned as desired to receive and store feed additives, either singularly or in admixture. First portion 14 comprises a wall segment 16. Hopper 12 comprises a second portion 18 comprising an angled wall segment 20 angled relative to wall segment 16 of section 14. In the illustrated embodiment, wall segment 20 defined an angle of approximately 45° or greater relative to wall segment 16. While an angle of approximately 45° or greater is not critical, this angle was particularly selected in an exemplary working embodiment to facilitate gravity feed of feed additive from hopper 12 to other downstream components and to reduce damage to product flowing from the hopper. Hopper 12 includes a support frame comprising support members 22, 24 and 26. A person of ordinary skill in the art will understand that hopper 12 could be sized or shaped differently than the embodiment illustrated by FIG. 1 and still function appropriately. Plural feed additive hoppers and associated dispensing components could be used to dispense plural different feed additives. Alternatively, hopper 12 is not a required component. For example, continuous flow of product could be provided to downstream components by a continuous input line from a substantially unlimited source relative to the amount of feed additive dispensed by the device 10 for feed/feed additive batching.

Certain working embodiments included an air pressure inlet line to introduce a pressurized air supply into a top portion of hopper 12 to facilitate product flow from the hopper to downstream delivery lines without using an intermediary feed additive dispensing component, such as the rotary valve assembly discussed in more detail below. These exemplary working embodiments established that the amount of feed additive dispensed by the device varied too extensively as the amount of product in hopper 12 varied with time and dispensation. Accordingly, while a potential optional delivery method, this approach did not prove as accurate in delivering product amounts as did other disclosed embodiments. Hopper 12 is coupled to a rotary valve assembly 50 using an intermediate connector 52. Connector 52 comprises a first plate 54 for coupling the valve assembly 50 to hopper 12, such as by bolting the first plate to the hopper via apertures 55. Connector 54 includes a second connector plate 56 that is coupled to rotary valve assembly 50 using bolts 58.

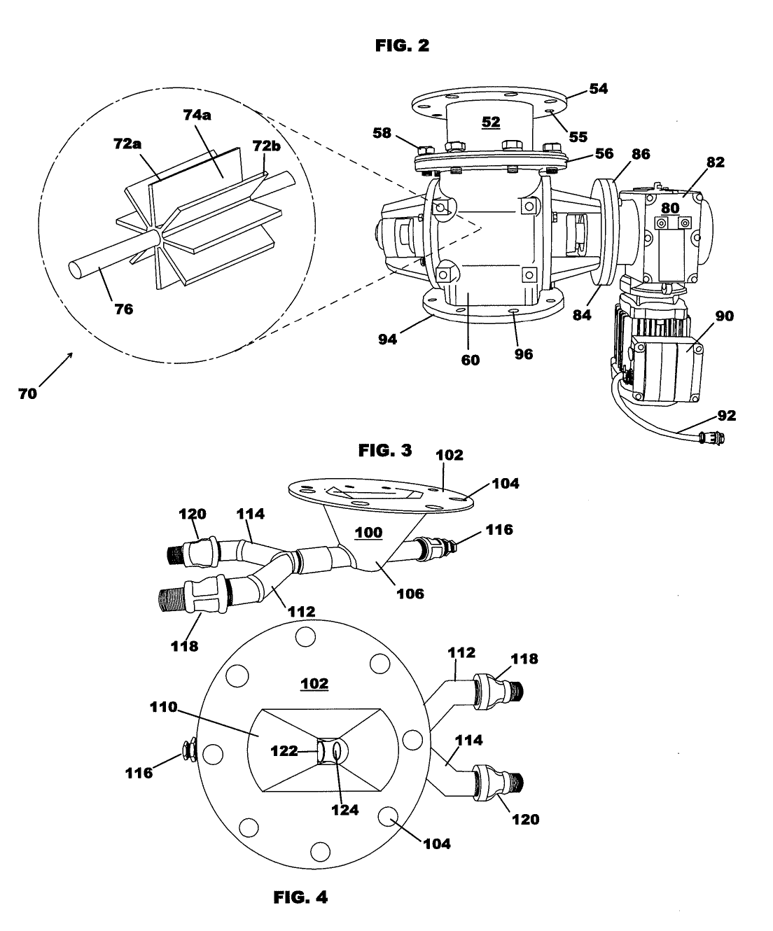

Rotary valve assembly 50 includes housing 60 that defines an internal housing portion for housing rotary valve 70, illustrated in the isolated perspective view of FIG. 2. Rotary valve 70 meters product received from hopper 12 for delivery to product output lines. Rotary valve 70 includes plural vanes 72a, 72b. An exemplary embodiment included 16 2 inch by 4 inch vanes 72, and the overall rotary valve was a 6 inch valve. Plural product receiving regions 74 are defined between two adjacent vanes 72. For example, a product receiving region 74a is defined between adjacent vanes 72a, 72b. Regions 74 define a known volume for receiving a known amount of feed additive from hopper 12. Device 10 is designed to accurately dispense a known amount of feed additive. The accuracy of the rotary valve 70 to deliver feed additive is affected by the amount of feed additive, and the weight variance thereof, received by adjacent regions 74 per valve rotation. The greater the number of vanes 72, the greater the number of receiving regions 74, and the more accurately feed additive can be dispensed using the device 10. A commercially available rotary valve having 8 vanes 72 was initially selected. This commercially available valve was subsequently modified to include 16 vanes, which substantially increased the feed additive dispensing accuracy of device 10. A person of ordinary skill in the art will appreciate that the number of vanes 72 could be increased from 16, such as to 32 or 64 vanes, to further reduce the variance in the amount of feed additive dispensed by device 10. For certain working embodiments comprising 16 vanes 72, regions 74 received about 17 grams of feed additive per rotation of rotary valve 70.

Rotary valve 70 is coupled by shaft 76 to a gear assembly 80. Gear assembly 80 includes a housing 82 for housing gears (not shown). Rotary valve assembly housing 60 includes a connector plate 84 for coupling to gear assembly housing 82 via connector plate 86. A working embodiment of device 10 used an 18:1 gear assembly. Rotary valve assembly 50 also includes a motor 90 and a power supply cord 92. Motor 90 operated at about 1,750 rpm in an exemplary working embodiment, but was coupled to the 18:1 gear assembly to provide a desired slower valve rotation. Motor 90 can be coupled to a frequency converter (not shown) to provide additional product delivery rate control. Accordingly, the rotation speed of rotary valve 70 can be varied as desired to deliver a known amount of feed additive per unit time.

For example, the manufacturer's suggested administration amount of polymer-coated methionine is 14 grams/head/day, although this amount often is varied by end users to be between about 7 grams/head/day to 14 grams/head/day. For certain working embodiments, a device 10 dispensed about 3,000 grams of polymer-coated methionine to 30,000 pounds of animal feed. The 3,000 grams was mixed with the feed in a suitably short time period, such as about 1 minute. In order to deliver this desired amount of feed additive accurately in the set time period, the rotary valve operated at about 3 rpm to about 5 rpm, but was capable of substantially greater rotations per minute of at least about 20 rpm. Other additives, such as yeast-based products, vitamins and minerals, typically are being mixed with the feed either serially or simultaneously by a micro weigh machine, and a uniform mix of all ingredients is required. Controlling the delivery rate allows device 10 to accurately dispense a substantially uniform amount of feed additives so that each animal receives the suggested feed additive dosage.

Rotary valve assembly 50 includes connector plate 94 for coupling the assembly to a two direction blow through plate assembly 100. Assembly 100 includes connector plate 102 having plural apertures 104 for coupling to valve assembly 50 via apertures 96. Assembly 100 includes a housing 106 that defines a product receiving chamber 110 sized to receive that amount of feed additive delivered to the chamber by each region 74 of rotary valve 70. Chamber 110 is plumbed to two outlet conduits 112, 114. Conduits 112, 114 include line fittings 118, 120 for receiving outlet lines 130, 132 (FIG. 1).

Blow through plate assembly 100 also includes an air inlet port 116 on an upstream portion thereof. Housing 106 defines air inlet 122 for receiving air introduced to the chamber 110 through inlet port 116. Housing 106 also includes a feed additive outlet port 124 fluidly coupled to conduits 112, 114.

A person of ordinary skill in the art will understand that a structure other than a rotary valve can be used to deliver feed additive to the blow through plate assembly 100. For example, device 10 could include a slide gate (not shown) for metering feed additive from the hopper 12 to the blow through plate assembly 100. Accurate product delivery could be determined by weighing product dispensed from the hopper 12.

Hopper 12, associated rotary valve assembly 50 and blow through assembly 100 are positioned on a scale 28. While any suitable scale may be used, the particular scale 28 used in an exemplary working embodiment was a 36 inch by 36 inch scale having an accuracy of about 1 gram. Scale 28 allows amounts dispensed by device 10 to be determined by subtractive weighing. For example, prior to dispensing a feed additive a first weight is obtained using scale 28. After dispensing feed additive, a second weight is determined. The amount of feed additive dispensed is calculated by subtracting the second weight from the first weight. Subtractive weighing is particularly effective for simultaneously dispensing plural feed additives from separate feed additive hoppers of a feed additive device and/or plural feed additive hoppers of a micro weigh machine, discussed below. Subtractive weighing typically requires that each feed additive device, or each feed additive container of a micro weigh machine, be positioned on its own dedicated scale or operably associated with its own dedicated load cell. Additive weighing determines the weight of feed additives added after each particular additive is dispensed serially. For example, additive weighing can be used to serially determine the amounts of plural different feed additives added to a weigh hopper of a micro weigh machine after each feed additive addition. A person of ordinary skill in the art will appreciate that subtractive weighing, additive weighing, or both, can be used to form an animal feed/feed additive composition using disclosed embodiments of the feed additive device and system comprising the device according to the present invention.

With reference to FIG. 1, apparatus 10 includes two outlet product lines 130, 132. This allows the device 10 to deliver feed additive to at least two different feed formulations, to two different receivers, such as separate mixer or weigh hoppers, to aqueous feed additive slurries, and any combination thereof. A person of ordinary skill in the art will appreciate that the number of feed additive outlet lines can be increased as required to deliver feed additive to a desired end number of receivers. T-connectors 134, 136 are inserted into the respective ends of each outlet line 130, 132. Downstream outlet portions of the T-adaptors include inline connectors 138, 140 for connection to feed additive delivery lines 142, 144 for delivering feed additive to a downstream component, such as a micro weigh machine weigh hopper, or to a feed formulation. Mixer hoppers receive feed, and plural feed additives from a micro weigh machine, for mixing with the particular feed additive(s) dispensed by apparatus 10. The outlet product lines 130/142, 132/144 have substantially the same length so that the amount of feed additive delivered to a receiver is substantially equivalent in each of the plural feed additive outlet lines. In a working embodiment, the outlet lines were 80 feet long, 1 inch diameter lines.

T-connectors 134, 136 are fluidly coupled to two solenoid valves 150, 152. Solenoid valves 150, 152 are positioned inline between T-connectors 134, 136 and two fluid lines 154, 156. Lines 154, 156 are fluidly connected to a second T-connector 158. T-connector 158 is also coupled to fluid line 160, which in turn is coupled to an inline pressure regulator 162. Inline pressure regulator 162 is coupled via fluid line 164 to an outlet port 166 of compressor 170. Compressor 170 comprises an air housing 172 and a compressor motor 174. For a working embodiment, the compressor operated at a pressure of about 100 psi as measured at pressure regulator 166. The illustrated embodiment of compressor 170 includes wheels 176 and housing stand 178, and hence can be moved as desired by an operator.

Solenoid valves 150, 152 are electrically coupled to a control panel 180 of a micro weigh machine via electrical lines 182, 184. Device 10 is directly integrated with a micro weigh machine by control panel 180 without any modifications. Control and operation of an exemplary micro weigh machine is discussed in more detail below.

Positive pressure dispensation of product through the two direction blow through assembly 100, while a viable embodiment, did not dispense feed additive as efficaciously as did the illustrated embodiment 10. Actuation of solenoid valves 150, 152 by control panel 180 results in air flow through lines 142, 144 downstream of blow through assembly 100. This flow causes a venturi effect that creates a sufficiently lower pressure between the blow through plate assembly 100 and the product delivery conduits 130/142, 132/144 to draw feed additive from the assembly through the delivery lines and to downstream receivers.

Experience with prototype embodiments indicated that feed additive dispensation was substantially facilitated by drawing air through the port 116 relative to devices that did not include the port. Port 116 is sized appropriately to allow sufficient air flow through the blow through plate assembly 100 to carry feed additive from receiving chamber 110 through the appropriate feed additive delivery line 130/142 or 132/144. A working embodiment included a ⅜ inch port 116.

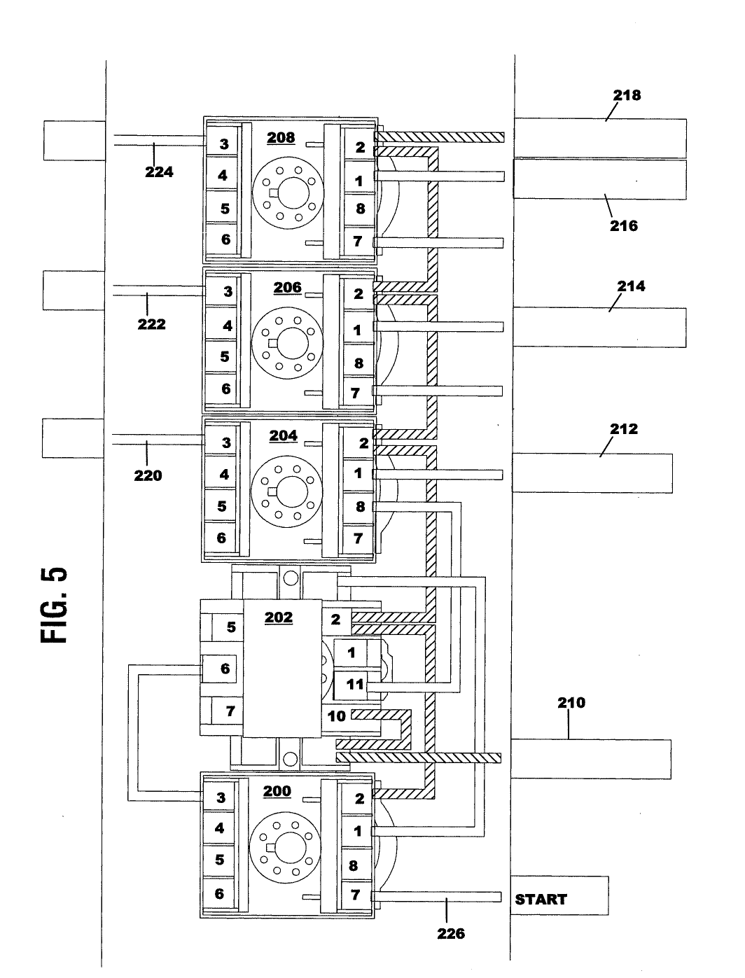

FIG. 5 is a top view of plural electrical relays 200, 202, 204, 206 and 208 for the illustrated embodiment 1. Power into each of relays 202, 204, 206 and 208 can be regulated neutral input, or unregulated 112 volt input, as the need dictates. For a particular embodiment, electrical input 210 received 120 volt regulated power; power inlet 212 received 120 volt unregulated power; power inlet 214 received 120 volt unregulated power; power inlet 216 received 120 volt unregulated power; and power inlet 218 received 120 volt regulated neutral power. Each of relays 204, 206 and 208 was electrically coupled via lines 220, 222 and 224 to inline air solenoids 150, 152 and to compressor 170. A start input line 226 is electrically coupled to control box 180 of a desired integrated micro weigh machine.

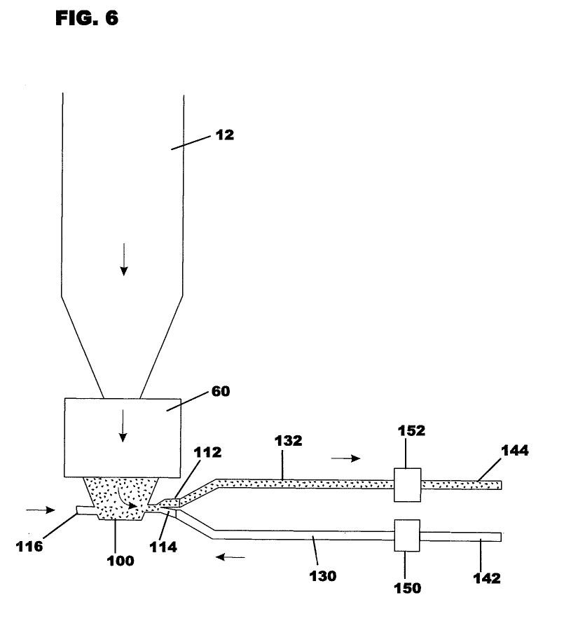

Operation of device 10 is controlled by a control processor of a micro weigh machine. With reference to FIG. 6, feed additive housed in hopper 12 gravity feeds to rotary valve 70 in housing 60. Upon receiving a start signal from a micro weigh machine, rotary valve 70 begins to rotate at a desired rpm as determined by considering desired product dispensation rate from hopper 12. Upon actuation of solenoids 150, 152, air supplied by compressor 170 flows through the appropriate delivery lines 130/142, 132/144. Concurrently, air flow is drawn through air inlet 116. FIG. 6 illustrates that air flow for feed additive delivery through a first delivery line, such as line 132/144, is in a first product delivery direction, whereas air flow in a second line, such as line 130/142, is in the opposite direction back towards blow through plate assembly 100. This air flow arrangement substantially prevents feed additive build up at the Y defined by conduits 112 and 114. Introducing compressed air flow from compressor 170 to a feed additive delivery line 142 or 144 as desired creates an area of lower pressure behind its flow in a respective feed additive delivery line 130, 132. This effectively draws feed additive dispensed by rotary valve 70 into chamber 110 of the two direction blow through assembly 100 into an appropriate line 130 or 132. A person of ordinary skill in the art will appreciate that the pressure differential required to draw feed additive from the two direction blow plate 100 may vary, depending on a number of factors, including but not limited to, the nature of the product, such as size, shape, cohesiveness, etc.; the rate at which product needs to be dispensed; the distance over which product must be dispensed for mixing with feed, feed additives, and combinations thereof; etc. For current embodiments, pressures range from about 40 psi to at least about 150 psi, with working embodiments operating at pressures of about 112 psi.

Accurate dispensing of desired amounts of a feed additive is an important aspect of the disclosed embodiments. Certain embodiments verify accurate feed additive dispensation by subtractive weighing, by delivering feed additive to a weigh hopper where weights are periodically determined as feed additive is delivered to the weigh hopper, and delivered amounts are verified by either subtractive weighing, additive weighing, or both. For example, a weigh hopper weight is first determined prior to initiating feed additive batching. The feed additive delivery device operates at a known dispensation rate, which rate is stored by the control computer, typically as grams delivered/second. As feed additive is delivered to a weigh hopper, the control computer monitors the product delivery time relative to the product delivery rate, while simultaneously periodically determining actual weight amounts delivered to the weigh hopper, to accurately assess the amount of feed additive dispensed. A certain amount of feed additive continues to flow through the device after a dispensing stop signal stops continued feed additive delivery. This amount, referred to herein as “free fall,” can vary for various delivery scenarios, such as differences in the product being delivered. The control computer has stored prior free fall amounts for a particular delivery scenario, and considers that free flow amount in a given batching sequence to facilitate accurate product delivery. The control computer can use feedback control to evaluate free flow amounts for each batching sequence and adjust the stored free flow amount for use in a subsequent batching sequence.

### III. Micro Weigh Machine

### 1. Introduction

Embodiments of the disclosed feed additive delivery device may be integrated into a system comprising a micro weigh machine that controls dispensation of feed additive from the delivery device for mixing with feed, feed additives, or both. The following is a general description of one embodiment of a suitable micro weigh machine. Additional information concerning exemplary micro weigh machines is provided by U.S. Pat. Nos. 4,733,971 and 4,815,042, which are incorporated herein by reference.

### 2. General Assembly

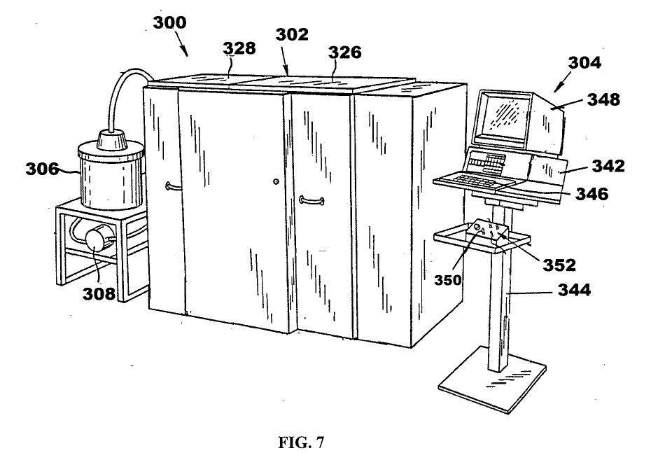

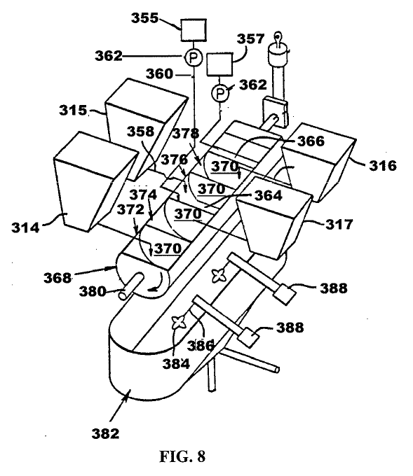

An apparatus shown generally at 300 in FIG. 7 useful for accurately measuring, dispensing, and delivering feed additives includes several separate components including a main cabinet 302, a remote control unit 304, at least one feed additive storage container 306, and a dispensing pump 308. Typically, a separate water supply tank supplies carrier and flush water to the cabinet through fill and flush conduits via a booster pump.

Another separate cabinet (not shown) houses a computer for controlling the machine sequencing, any volumetric metering and weight functions. Various speed controls and electrical relay interfaces and circuitry of the control system are also housed within cabinet portions.

Cabinet 302 houses the major mechanical components of the apparatus. The exterior of the cabinet, with its protective panels, completely encloses and shields such components from external dust, dirt and other contaminants common in a feedlot environment. The panels also protect the internal components, especially the weight-sensitive ones, from external forces such as wind, jarring contact, and the like, that would otherwise affect the accuracy of weight measurements.

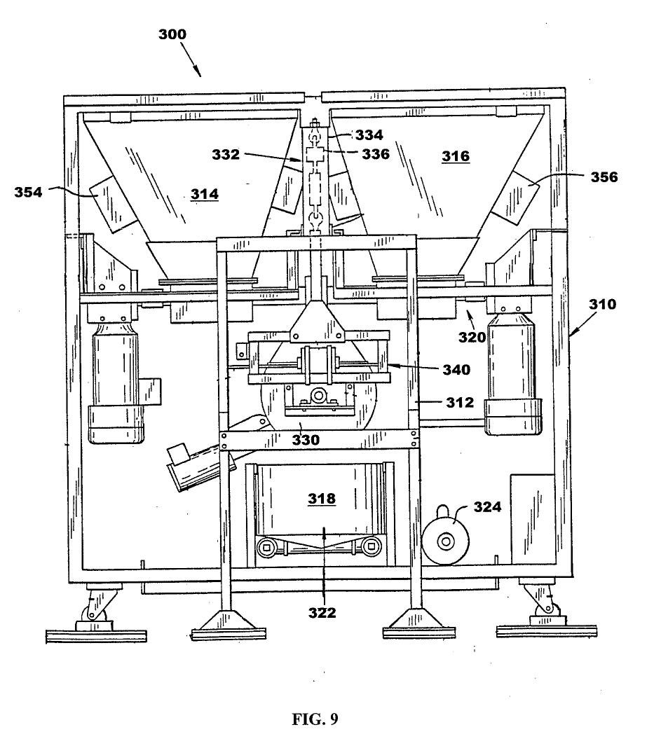

With reference to FIG. 9, the major components inside the cabinet include a main frame 310 and an entirely separate and independently mounted subframe 312, each mounting certain components. Access to the components mounted on these frames is gained through access doors. In general, weigh subframe 312 mounts those components necessary to the weighing function of the apparatus 300, and main frame 310 mounts the remaining components that could, during their operation, induce undesirable movements in the weigh components that adversely affect the weighing function. Accordingly, the weigh subframe 312 isolates the weigh components from internal machine movements induced through operation of components on the main frame.

The main frame components include plural dry feed additive storage bins 314, 316, for storing different dry additive concentrates, a dry additive dispenser 320 for dispensing additives from the storage bins, and a mixer 322. Other main frame-mounted components include a discharge pump 324 for pumping slurry from mixer 322, slurry mixers, and various plumbing components for supplying carrier and flush water to the mixer and discharging slurry liquid from the vessel.

Subframe 312 includes an entire subassembly of weigh components, including a weigh hopper and a suspension mechanism for suspending the weigh hopper 330. The suspension mechanism includes a pair of suspension frames, one at either end of the weigh hopper. Each such frame rotatably supports a weigh hopper 330. A weigh tower 334 projects upwardly from the subframe 312 and suspends a load cell 336. The load cell 336 in turn suspends the weigh hopper 330 through an appropriate connection to a suspension arm of a suspension frame 340.

The device also may include a remote control unit 304, such as a computer terminal 342 supported on a stand 344. Terminal 342 includes an input keyboard 346 and a display screen 348. Various controls 350 are provided on a control switch box 352.

### 3. Feed Additive Storage Containers

Micro weigh devices may include multiple dry additive storage bins for storing separately a plurality of different dry feed additives. Vibrator motors 354, 356 (FIG. 9) may be associated with the storage bins 314, 316 to assist in moving dry feed additives out of the bins during dispensing. With reference to FIG. 8, micro weigh machines also may include a plurality of liquid feed additive containers 355, 357 for storing separately different liquid feed additives. A separate dry dispenser 358 is provided for each dry bin 314, 315, 316, 317. A separate liquid dispenser 360 is provided for each liquid container 355, 357. Each liquid and dry dispenser is independently operated and controlled for dispensing separately several selected feed additives from their respective bins and liquid containers in predetermined weights during a machine operating cycle.

A dispenser may include a flow passageway of progressively decreasing cross section from a bottom bin opening to a top opening into a coreless metering screw assembly. Screw assembly includes a rotatable core which carries a helical metal screw and rectangular screw agitator with a circular band around one end thereof. A stationary rear one-half tube extension of a conveyor tube projects into the interior of agitator to start the conveyance of material that is moved by the screw into conveyor tube. The agitator helps maintain a uniform micro ingredient density around the rotating screw. The agitator is rotated by a shaft, which is driven through a right-angle gear box by a variable-speed motor. Certain embodiments include pre-set speed, such as three pre-set speeds. The metering screw assembly conveys additive from a supply bin into a compartment of the weigh hopper.

Each of the liquid containers 355, 357 also is provided with a separate dispenser, such as a variable-speed or displacement rotary or piston pump 362. The liquid dispenser pumps liquid additive from the containers 355, 357 through a flexible feed conduit to deliver the additive into a compartment 364, 366 of a weigh hopper 368. One embodiment of a weigh hopper 368 is an elongated trough having a substantially semi-cylindrical cross section and a plurality of partitions 370 which divide the hopper transversely into several feed additive receiving compartments 372, 374, 376, 378. Each of the dry compartments 372-378 is provided with a deflector on its partition wall that directs feed additive to the interior of the compartments during both filling and emptying of the hopper. Partitions define liquid additive-receiving compartments to receive liquid additives. The liquid and dry additive compartments of the hopper may maintain dispensed additives separated until the hopper discharges its contents, after weighing, such as into a diluting liquid carrier. Hopper 368 is supported by frame 312 such that it is free to rotate about its longitudinal axis. The hopper 368 is drivingly connected to a motor which operates to rotate hopper to an inverted position for emptying; then to an upright position (in the same direction) for the next dispensing and weighing cycle. The hopper 368 may be cleared using air flush comprising a compressor in fluid communication with the hopper. A solenoid valve regulates the flow of air into each compartment of the hopper when the hopper is inverted. A vibrator motor operates during inversion of the hopper to promote emptying of the hopper compartments by vibrating the hopper.

The micro weigh machine includes an elongated mixing vessel 382 for receiving additives from the hopper 368 and for mixing such additives together, or with additional materials, such as water. Each mixer comprises plural mixing blades 384 connected to a rotary mixing shaft 386 that is connected to a gearbox and motor 388 for rotating the shaft. Level sensors may also be in the mixing vessel 382 for determining the level of materials contained therein. The micro weigh machine delivers dispensed additives to a receiving station for mixing with an animal feed ration.

### 4. Weighing Device

A weighing device is provided on a weigh frame for weighing predetermined weights of the different feed additives dispensed from additive bins and containers. Certain embodiments include a weigh tower extending vertically upward from a crossbeam of a weigh frame from which a load cell is suspended. The load cell strain is communicated to a control unit. The load cell is capable of weighing to a desired accuracy, such as at least 0.5 grams. The device may further include vibration and sway dampening rods for preventing or damping transverse movements of the hopper that could affect accurate weight measurements.

### 5. Central Processing Unit and Weight Program

The apparatus includes at least one central processing unit for controlling operation. In one embodiment, two-programmed central processing units are used, one for operating the weighing functions, and the other for operating all other machine functions.

The weighing CPU is activated by starting the menu and then entering ration data with an input device, such as a keyboard, for a particular feedlot or data for one of a series of desired batches at a feedlot. The formulation of each desired batch may be preprogrammed into the computer such that a batch formulation can be selected. A program prompt requests the size of the batch to be prepared. After this information is entered by an operator, the program prompt requests the number of batches to be prepared.

The weighing computer first checks to determine if a weigh switch is on. The program next calculates metering ration data and sends it to the machine operating program. The metering data is calculated for any additives that have been selected for dispensing in the metering mode during the weigh cycle.

To prepare slurries comprising additives, the program sets an output for the water level determining how much water will be present in the slurry which is ultimately delivered to a receiving station. Water level information is sent to the machine operating program. The program next waits for a start signal, which the operator gives by activating a start switch. The weighing cycle is then started by sending a start signal to the machine operating program. Even though the weighing cycle has started, no weighing of feed additives actually commences until a signal is received back from the machine operating program. This communication between the programs enables the machine operating program to begin its initial checks while feed additives are being dispensed and weighed.

Once the signal to begin weighing is received, the weighing sequence begins. Mixers are also started so that the feed additives dumped from the hopper will be mixed and discharged to a receiving station. Feed additive flow is started by activating a motor for a screw below a dry feed additive bin. Alternatively, the computer can initiate a start sequence to the feed additive delivery device disclosed herein to initiate delivery of feed additive, such as a delicate and/or coated feed additive, using such device. The weight of feed additive introduced into compartment is determined by a load cell and that information is continually fed back to the computer. As the weight of feed additive dispensed approaches the predetermined amount selected for the batch formulation, the motor is switched to a lower speed that more slowly dispenses the concentrate during a final phase of dispensing. In this manner, a more accurate weight of feed additive can be dispensed from the bin.

When the predetermined weight of feed additive is sensed and the weighing of that component has been completed, the computer determines if the just dispensed concentrate was the last feed additive to be dispensed. Assuming the feed additive was not the only one to be dispensed in this formulation, the program then initiates a flow of feed additive from another bin by activating a motor associated with that bin. Alternatively, the computer can initiate a start sequence to initiate delivery of a second feed additive, such as a delicate and/or coated feed additive, using the feed additive delivery device discussed herein. The load cell continues to sense the weight of additive added to the hopper until that weight begins to approach the final predetermined desired weight of this second additive. This predetermined weight will be the total actual net weights of the first additive plus the predetermined weight of the second additive since the hopper has not yet inverted. As the total combined actual weight approaches the predetermined amount, the motor is switched to a slower speed, until the total combined weight of additive is reached, and motor is shut off.

This same procedure is repeated until the predetermined weights of desired additives for a particular formulation are dispensed from each bin and/or the feed additive delivery device disclosed herein. Liquid feed additives are dispensed by activating a liquid pump, which sequentially dispenses liquid additive into liquid receiving compartments into the hopper means until a predetermined amount of each liquid additive has been dispensed.

Once the last feed additive has been dispensed, the computer determines that weighing has been completed, which sends a signal to the machine sequence program. The computer pauses to wait for the hopper to discharge its load. Once the hopper dumping has been completed by inversion and the hopper returns to an upright position, this information is sent from the machine operating program to the weighing program. If another batch is required, the sequence repeats itself.

### 6. Machine Sequence Program

The weigh machine control program begins by determining if the weigh switch has been turned on. Once the weigh switch is on, the program is ready to receive a metering data signal. Once the metering data is received, the program is ready to batch. For slurry formation embodiments, the control program receives water level data, and then the machine cycle is started. A boost pump is then turned on to introduce the selected amount of water. If the predetermined water level is not reached within a set period of time, an alarm sounds to indicate that an error has occurred. Otherwise, if mixing vessel fills within the set time, this condition is detected by a level probe and mixing blade motors are activated. Liquid feed additives may be added by volumetric metering instead of weighing by activating the dispenser pump for a predetermined period of time. Once the metering step is completed, a motor is actuated to invert the hopper to dispense the feed additive contained in the hopper compartments. Once the hopper is inverted, vibrators on the hopper are activated to promote complete removal of all feed additive particles. A compressor is next actuated to compress air in an air tank, and a solenoid is opened to flow air through lines and toward walls of each compartment to remove any traces of solid feed additives. Air flushing continues for a predetermined period of time.

The hopper is then sent to its home position by activating a hopper motor. When the hopper returns to its upright position a signal is sent that the contents have been dumped, and another weigh cycle can begin. Meanwhile the machine operating program switches mixer motors to a higher speed for a predetermined mixing time. Once the preselected mixing time expires the mixing motors are switched back to their lower speed. A discharge signal is sent by the program to discharge the slurry. A solenoid valve then opens, and a pump is activated to remove the slurry. A timed flush cycle may be implemented by activating a boost pump to introduce flush water through a flush line and into the vessel to completely remove any feed additive from the vessel. The boost pump continues introducing a water flush for a predetermined flush time period, and the flush is then terminated.

### 7. Electrical Functions

Most cattle yards and other users are located in rural areas where variations in power may adversely affect operation of the computers which control weighing and sequencing of machine function. For that reason, a series of transformers may be used to selectively filter the electrical energy, isolate the power source, and damp variations in the power before it is supplied to the computers.

Four hundred eighty volts of power are supplied by a rural electrical utility through a 10 kw isolation transformer where it is transformed into 240 V power. This initially filtered 240 V power is supplied to an electrical connection line through a relay to a booster pump that introduces water into a mixing tank during the filling and flushing cycles. The 240 V power is also supplied through a relay to a second pump for draining the mixing tank. This relatively unfiltered power can be supplied to pumps since they are not as sensitive to power variations as the computers.

The 240 V power is also sent to a sola-regulating transformer where it is transformed to 112 V power. This filtered, 112 V power is used to provide electrical energy to all components of the micro weigh machine other than the pumps. If electrical energy is interrupted, 12 V batteries connected in series are provided as an uninterruptable power supply.

A remote control unit includes monitor screens and keyboards for weighing and metering functions. The remote control unit is electrically connected to a weigh computer and to a machine sequencing computer. Computer interface provides a data bus between the weigh computer and the machine sequencing computer.

The machine sequencing computer and weigh computer are supplied with 5 V power from triple power supply through line. I/O boards are supplied with 112 V power.

Load cells are electronically connected to the weigh computer. Weight determinations are made periodically and to determine the feed additive dispensation rate using a speed control. The speed control operates the dispenser screw at a preset metering speed for a predetermined amount of time.

### 8. Alternative Micro Weigh Machine Embodiments

A person of ordinary skill in the art will understand that disclosed embodiments of the feed additive delivery device can be integrated into a system with any suitable micro weigh machine. For example, current micro weigh machine embodiments can dispense feed additives directly onto feed, into an aqueous stream to form a feed additive slurry, and then onto feed, as a dry material into a mixer, etc., and any combination thereof.

As another example, current micro weigh machine embodiments can determine the amount of feed additive dispensed either by subtractive weighing, additive weighing, or both. For subtractive weighing, a micro weigh machine typically includes plural feed additive bins, such as from 1-20 bins, more typically from 1-15 bins, and even more typically from 1-10 bins, with each bin storing a particular feed additive. Each feed additive bin is operably associated with its own scale or load cell to accurately determine weight of product dispensed from that bin by taking a first bin weight, dispensing product, determining a second weight, and using the first and second weights to determine the weight of feed additive dispensed from each bin. This allows simultaneous dispensation of plural different feed additives from each feed additive bin directly onto feed, into a water stream to form an aqueous slurry for dispensing onto feed, into a weigh hopper, into a mixer for mixing the formulation, etc.

Other micro weigh machines use additive weighing to determine the amount of feed additive added to, for example, a mixer or a weigh hopper. Because the weight of each feed additive dispensed must be determined accurately, additive weight determination typically involves dispensing a first product into, for example, a weigh hopper having a known weight, wherein the weigh hopper is positioned on or operably associated with a load cell; weighing the weigh hopper to determine the amount of a first additive added to the weigh hopper; adding a second feed additive to the weigh hopper; determining a second weight of the weigh hopper to determine the amount of second feed additive added to the weigh hopper; etc., for each feed additive added to form a particular feed batch.

Micro weigh machines incorporating these, and other alternative structural and/or methodological differences from those described herein, can be used with disclosed embodiments of the feed additive delivery device.

### IV. Feed Additives

While the described embodiments have multiple benefits and purposes, the feed additive delivery device was particularly developed to dispense certain feed additives. In particular embodiments, the feed additives are delicate particles that are damaged by known feed additive delivery mechanisms; are coated additives, wherein the coating may be disrupted, broken and/or destroyed by delivery techniques and devices known prior to the present invention; or both.

One such product is methionine, shown below.

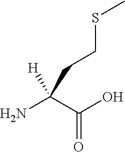

Methionine breaks down in the rumen of ruminants. Accordingly, feed additives for ruminants are purposefully designed to protect methionine from degradation in the rumen while allowing appropriate adsorption levels in the digestive tract. An example, without limitation, of a coated methionine product is Smartamine® M, which comprises methionine coated with a pH-sensitive polymer to protect the methionine while in the rumen, while nevertheless allowing methionine release in the abomasum and absorption in the small intestine.

While the present device has proved suitable for delivering feed additives, particularly coated feed additives, such as Smartamine®-type products, a person of ordinary skill in the art will appreciate that such device can be used to deliver other products, particularly products intended for administration to feed animals, such as ruminants, and particularly cattle. Exemplary feed additives include antibiotics, amino acids, therapeutics, proteins, enzymes, vitamins, and other nutritional supplements that are typically administered to animals, including cattle and poultry at feedlots, in gram amounts or less. Physical properties of these products can be considered to determine if efficacious product delivery would be facilitated using presently disclosed embodiments. For example, spherical pellets, particularly relatively small BB-sized products, also can be effectively dispensed by disclosed embodiments of the feed additive delivery device.

It is often essential that a prescribed amount of a micro ingredient be delivered to an animal, and no more. Too little of a micro ingredient has no effect; too much may be toxic or fatal. The range between too much or too little of some additives is often no more than 0.5 gram/head. The apparatus and system disclosed in this detailed description dispense feed additives with this accuracy.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A feed additive delivery device, comprising:
a feed additive source;
a blow through assembly having an assembly inlet that receives feed additive from the source and an assembly outlet through which feed additive is dispensed;
at least one feed additive delivery line coupled to the assembly outlet; and
a pressurized air source for delivering pressurized air to the at least one feed additive delivery line downstream of the blow through delivery assembly to create a region of lower pressure to draw product from the assembly.

2. The device according to claim 1 wherein the feed additive source is a hopper coupled to the assembly, wherein the hopper has a first wall portion and a second wall that is angled relative to the first wall portion to facilitate feed additive flow from the device.

3. The device according to claim 1 further comprising a metering device positioned between the feed additive source and the blow through assembly for metering feed additive to the assembly.

4. The device according to claim 3 wherein the metering device comprises a rotary valve having from 8 to 64 vanes that define feed additive receiving regions therebetween to receive a known volume of feed additive, the rotary valve being coupled to a motor and gear box for rotating the valve at a desired rate.

5. The device according to claim 1 further comprising a compressor and a solenoid valve for delivering and regulating air flow to the at least one feed additive delivery line.

6. The device according to claim 1 comprising first and second feed additive delivery lines, wherein the first and second feed additive delivery lines include independently controllable solenoid valves.

7. The device according to claim 1 further comprising a control computer.

8. The device according to claim 7 wherein the solenoid valves are operably coupled to a micro weigh machine control computer for controlling valve actuation.

9. The device according to claim 8 wherein actuation of the solenoid valves produces air flow in a first feed additive delivery line in a feed additive delivery direction and produces air flow through the second feed additive delivery line in an opposite direction back to the assembly.

10. The device according to claim 2 further comprising a scale upon which the hopper, rotary valve and blow through assembly are operatively positioned to determine weight of feed additive dispensed from the device.

11. The feed additive delivery device according to claim 1, comprising:
a feed additive hopper;
a rotary valve coupled to a motor and a gear box for rotating the valve at selectable rotation rates, the valve comprising 8 to 64 vanes that define feed additive receiving regions therebetween to receive a known volume of feed additive;
a blow through assembly having an assembly inlet that receives feed additive from the rotary valve, an assembly outlet through which feed additive is dispensed, and an air port for drawing air into the assembly to facilitate feed additive dispensation through the assembly outlet port;
a scale or load cell operably associated with the hopper, the rotary valve and the blow through assembly; and
a pressurized fluid source for delivering pressurized fluid to first and second feed additive delivery lines coupled to the assembly outlet, the first and second feed additive delivery lines comprising independently controllable solenoid valves coupled to a control computer of a micro weigh machine for actuation to draw feed additive from the blow through assembly and through a feed additive delivery line.

12. The device according to claim 11 wherein actuation of the solenoid valves produces air flow in the first feed additive delivery line in a feed additive delivery direction and produces air flow through the second feed additive delivery line in an opposite direction back to the assembly.

13. A system, comprising:
a feed additive delivery device according to claim 1; and
a micro weigh machine comprising a control computer operatively coupled to the feed additive delivery device for controlling dispensation of feed additive thereby.

14. The system according to claim 13 where the feed additive delivery device delivers feed additive directly onto feed, to a vehicle having feed, a weigh hopper of the micro weigh machine, an aqueous slurry prepared by the micro weigh machine, or combinations thereof.

15. The system according to claim 13 wherein the micro weigh machine includes plural feed additive storage containers for storing a feed additive selected from antibiotics, amino acids, therapeutics, proteins, enzymes, vitamins, and other nutritional supplements, and the feed additive source comprises a feed additive hopper that stores coated methionine.

16. A method, comprising;
providing a feed additive delivery device, or system comprising the device, according to claim 1; and
using the device or system.

17. The method according to claim 16 wherein the system is used to formulate a feed additive and feed composition suitable for administration to poultry, ruminants or swine.

18. The method according to claim 16 wherein the feed additive delivery device dispenses a coated feed additive, a delicate feed additive, or combinations thereof.

19. The method according to claim 18 wherein the coated feed additive is a coated methionine product.

20. The method according to claim 16, wherein the system comprises:
a feed additive delivery device comprising a feed additive hopper, a blow through assembly that receives feed additive from the source, the assembly having an outlet through which feed additive is dispensed, at least one feed additive delivery line coupled to the outlet of the blow through delivery assembly, and a pressurized fluid source for delivering pressurized fluid to the at least one feed additive delivery line downstream of the blow through delivery assembly to draw product from the assembly through the feed additive delivery line; and
a micro weigh machine operatively connected to the feed additive delivery device.

21. The method according to claim 20 wherein the feed additive delivery device further comprises a rotary valve positioned between the hopper and the blow through assembly for metering feed additive to the assembly, the rotary valve comprising plural vanes that define feed additive receiving regions therebetween for delivering a known volume of feed additive to the blow through assembly, the rotary valve being coupled to a motor and gear box for rotating the valve at a desired rate.

22. The method according to claim 20 where the micro weigh machine comprises a control computer that initiates rotation of the rotary valve at a predetermined rate for a predetermined time period.

23. The method according to claim 22 wherein the rotary valve delivers coated methionine feed additive to form a feed composition comprising from about 7 grams/head to about 20 grams/head coated methionine.
